(19) United States
(12) Patent Application Publication
(10) Pub. No.: US 2009/0150806 A1
(43) Pub. Date: Jun. 11, 2009

(54) Method, System and Apparatus for Contextual Aggregation of Media Content and Presentation of Such Aggregated Media Content

(76) Inventors: Bryon P. Evje, Roswell, GA (US); Ezra Suveyke, New York, NY (US)

Correspondence Address: GORDON & JACOBSON, P.C., 60 LONG RIDGE ROAD, SUITE 407, STAMFORD, CT, 06902, US

(21) Appl. No.: 11/953,361

(22) Filed: Dec. 10, 2007

(51) Int. Cl. G06F 3/00

(52) U.S. Cl. 715/762

(57) ABSTRACT

A method, system and apparatus for aggregating data content maintain a library of media content items. A user interacts with a client machine to display and interact with information (i.e., text content, image content, video content, audio content or any combination thereof). In conjunction therewith, meta-data is automatically generated that is related to the information presented to the user. A contextual link engine identifies particular media content items of the library that correspond to the meta-data, builds a graphical user interface that enables user access to the particular media content items, and outputs the graphical user interface for communication to the client machine. The graphical user interface presents text characterizing the particular media content items and links related thereto (selection of which preferably invoke communication of a message to the contextual link engine in order to initiate generation of a second graphical user interface at the contextual link engine).

### BACKGROUND OF THE INVENTION

1. Field of the Invention

This invention relates to aggregation of information available on the world wide web.

2. State of the Art

Modern search engines provide for contextual aggregation of information related to user-supplied search terms. For example, Google™ has introduced a technology called “Co-op” whereby publishers submit content from their Web sites with XML tags that make it easy for their content to be categorized in topic maps that appear above the main Google search results. When a user enters a search query on Google™ that matches a topic, a listing of subtopics that have tagged content available appears above normal search results. Clicking on one of these subtopics then displays a listing of search results relating to that subtopic—with tagged content appearing at the top of the list.

“Portals” and “Mashups” are web applications that provide for aggregation of information available on the world wide web. Portals are an older technology designed as an extension to traditional dynamic web applications, in which the process of converting data content into web pages is split into two phases—generation of markup “fragments” and aggregation of the fragments into pages. Each of these markup fragments is generated by a “portlet”, and the portal combines them into a single web page. Portlets may be hosted locally on the portal server or remotely on another server.

A “mashup” combines data from more than one source into a single integrated tool. A typical example is the use of cartographic data from Google Maps to add location information to real-estate data from Craigslist, thereby creating a new and distinct web service that was not originally envisaged by either source. Content used in mashups is typically sourced from a third party via a public interface or API, although some in the community believe that cases where private interfaces are used should not count as mashups. Other methods of sourcing content for mashups include Web feeds (e.g. RSS or Atom), web services and Screen scraping. Mashups are typically organized into three general types: consumer mashups, data mashups, and business mashups.

The most well-known type is the consumer mashup, best exemplified by the many Google Maps applications. Consumer mashups combine data elements from multiple sources, hiding this behind a simple unified graphical interface. Other common types are “data mashups” and “enterprise mashups”. A data mashup mixes data of similar types from different sources, as for example combining the data from multiple RSS feeds into a single feed with a graphical front end. An enterprise mashup usually integrates data from internal and external sources—for example, it could create a market share report by combining an external list of all houses sold in the last week with internal data about which houses one agency sold. A business mashup is a combination of all the above, focusing on both data aggregation and presentation, and additionally adding collaborative functionality, making the end result suitable for use as a business application.

### SUMMARY OF THE INVENTION

The present invention provides a method, system and apparatus for aggregating data content that maintains a library of media content items. A user interacts with a client machine to display and interact with information, which can be text content, image content, video content, audio content or any combination thereof. In conjunction with such interaction, meta-data is automatically generated that is related to the information presented to the user. Such meta-data provides context for the information presented to the user. A contextual link engine identifies particular media content items that correspond to the meta-data, builds a graphical user interface that enables user access to these particular media content items, and outputs the graphical user interface for communication to the client machine where it is rendered thereon. The graphical user interface presents text characterizing the particular media content items and links to the particular media content items, which preferably invoke communication of a message to the contextual link engine upon user selection in order to initiate generation of a second graphical user interface at the contextual link engine. The second graphical user interface enables user access to particular media content items corresponding to a media content item identified by such message. The second graphical user interface is output to the client machine where it is rendered thereon. User selection of a given link that is part of the first and/or second graphical user interfaces can invoke presentation of a pop-up window for playback of a media content item or can invoke inline playback of a media content item.

It will be appreciated that such automated content aggregation processing is suitable for many users, applications and/or environments and can be efficiently integrated into existing information serving architectures. In many applications, the automated content aggregation processing of the present invention can avoid user-assisted tagging of data content to identify related content, which is time consuming, cumbersome and prone to error as the data content changes over time.

According to one embodiment of the invention, tags are associated with each media content item of the library and the media content items that correspond to the meta-data for the requested data are identified by i) deriving at least one descriptor corresponding to the meta-data, and ii) identifying media content items whose tags match the at least one descriptor corresponding to the meta-data.

According to another embodiment of the invention, user-side processing of the client machine automatically generates the meta-data which provides context for the information presented to the user. Such user-side processing is preferably integrated as part of a web browser environment where the user client machine issues requests for data content. For each given request, meta-data related to data returned in response to the given request is automatically generated. Preferably, the meta-data is generated by execution of a user-side script on the client machine that issued the given request. The user-side script can be communicated from the server to the client machine in response to the request issued by the client machine. Alternatively, the user-side script can be persistently stored locally on the client machine prior to the request being issued by the client machine. The user-side script preferably derives meta-data pertaining to a particular request by extracting information embedded as part of the requested data. The extracted information can include at least one of a title, a description, at least one keyword, and at least one link.

Additional objects and advantages of the invention will become apparent to those skilled in the art upon reference to the detailed description taken in conjunction with the provided figures.

### BRIEF DESCRIPTION OF THE DRAWINGS

FIG. 1 is a schematic diagram illustrating a system architecture for realizing the present invention.

FIGS. 2A1 and 2A2 illustrate an exemplary HTML document together with an exemplary graphical user interface generated by the contextual link engine of FIG. 1 as rendered by the client machine of FIG. 1 in accordance with the present invention.

FIG. 2B illustrates an exemplary graphical user interface generated by the contextual link engine of FIG. 1 as rendered by the client machine of FIG. 1 in accordance with the present invention; the graphical user interface of FIG. 2B is generated by the contextual link engine and rendered by the client machine in response to user selection of a particular media content item of the interface of FIGS. 2A1 and 2A2.

FIGS. 3A1 and 3A2 illustrate another exemplary HTML document together with an exemplary graphical user interface generated by the contextual link engine of FIG. 1 as rendered by the client machine of FIG. 1 in accordance with the present invention.

FIG. 3B illustrates another exemplary graphical user interface generated by the contextual link engine of FIG. 1 as rendered by the client machine of FIG. 1 in accordance with the present invention; the graphical user interface of FIG. 3B is generated by the contextual link engine and rendered by the client machine in response to user selection of a particular media content item of the interface of FIGS. 3A1 and 3A2.

FIGS. 3C-3E illustrate yet another exemplary graphical user interface generated by the contextual link engine of FIG. 1 as rendered by the client machine of FIG. 1 in accordance with the present invention; the graphical user interface of FIGS. 3C-3E are generated by the contextual link engine and rendered by the client machine in response to user selection of a particular media content item of the interface of FIGS. 3A1 and 3A2.

FIGS. 4A1 and 4A2 illustrate another exemplary HTML document together with an exemplary graphical user interface generated by the contextual link engine of FIG. 1 as rendered by the client machine of FIG. 1 in accordance with the present invention.

FIG. 4B illustrates another exemplary graphical user interface generated by the contextual link engine of FIG. 1 as rendered by the client machine of FIG. 1 in accordance with the present invention; the graphical user interface of FIG. 4B is generated by the contextual link engine and rendered by the client machine in response to user selection of a particular media content item of the interface of FIGS. 4A1 and 4A2.

FIGS. 4C-4E illustrate still another exemplary graphical user interface generated by the contextual link engine of FIG. 1 as rendered by the client machine of FIG. 1 in accordance with the present invention; the graphical user interface of FIGS. 4C 4E are generated by the contextual link engine and rendered by the client machine in response to user selection of a particular media content item of the interface of FIGS. 4A1 and 4A2.

FIGS. 5A1 and 5A2 illustrate another exemplary HTML document together with an exemplary graphical user interface generated by the contextual link engine of FIG. 1 as rendered by the client machine of FIG. 1 in accordance with the present invention.

FIG. 5B illustrates another exemplary graphical user interface generated by the contextual link engine of FIG. 1 as rendered by the client machine of FIG. 1 in accordance with the present invention; the graphical user interface of FIG. 5B is generated by the contextual link engine and rendered by the client machine in response to user selection of a particular media content item of the interface of FIGS. 5A1 and 5A2.

FIGS. 5C and 5D illustrate still another exemplary graphical user interface generated by the contextual link engine of FIG. 1 as rendered by the client machine of FIG. 1 in accordance with the present invention; the graphical user interface of FIGS. 5C and 5D are generated by the contextual link engine and rendered by the client machine in response to user selection of a particular media content item of the interface of FIGS. 5A1 and 5A2.

### DETAILED DESCRIPTION OF THE PREFERRED EMBODIMENTS

Described herein is a system, method and apparatus for contextual aggregation of media content and for presentation of such aggregated media content to users. Media content, as used herein, refers to any type of video and audio content formats, including files with video content, audio content, image content (such as photos, sprites), and combinations thereof. Media content can also include metadata related to video content, audio content and/or image content. A common example of media content is a video file including two content streams, one video stream and one audio stream. However, the techniques described herein can be used with any number of file portions or streams, and may include metadata.

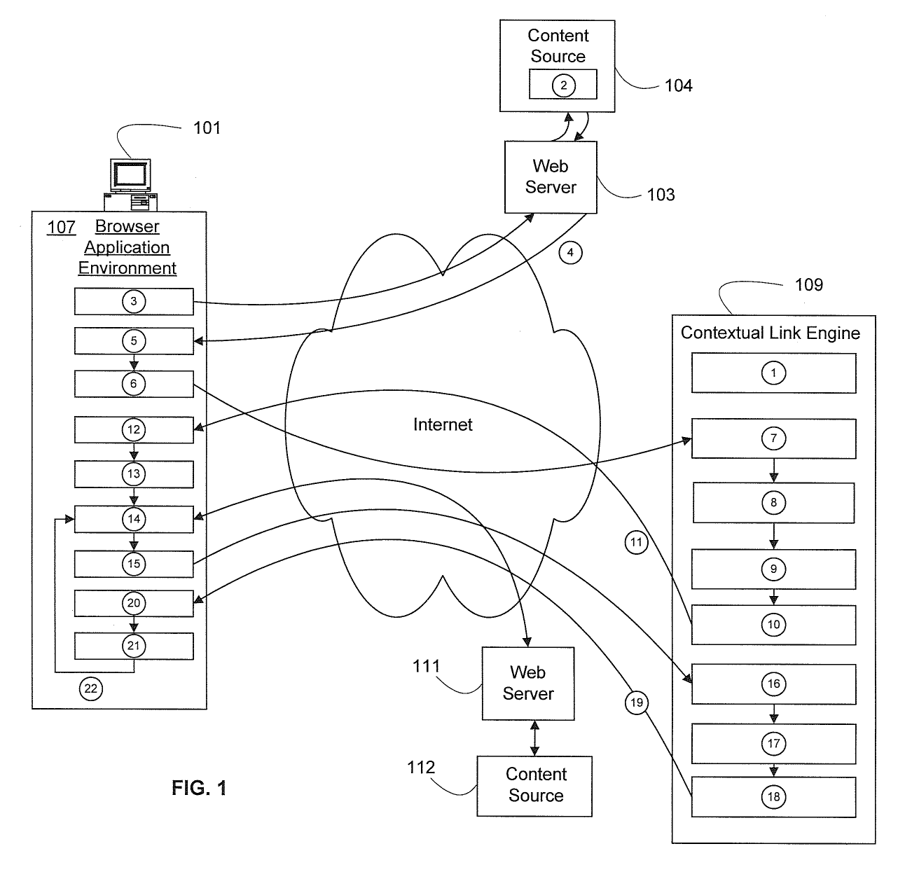

The present invention can be implemented in the context of a standard client-server system 100 as shown in FIG. 1, which includes a client machine 101 and one or more web servers (two shown as 103 and 111) communicatively coupled by a network 105. The client machine 101 can be any type of client computing device (e.g., desktop computer, notebook computer, PDA, cell-phone, networked kiosk, etc.) that includes a browser application environment 107 adapted to communicate over Internet related protocols (e.g., TCP/IP and HTTP) and display a user interface though which media content can be output. According to the present invention, the browser application environment 107 of the client machine 101 allows for contextual aggregation of media content and for presentation of such aggregated media content to the user as described herein. The client machine 101 includes a processor, an addressable memory, and other features (not illustrated) such as a display adapted to display video content, local memory, input/output ports, and a network interface. The network interface and a network communication protocol provide access to the network 105 and other computers (such as the web servers 103, 111 and the contextual link engine 109). The network 105 provides networked communication over TCP/IP connections and can be realized by the Internet, a LAN, a WAN, a MAN, a wired or wireless network, a private network, a virtual private network, or combinations thereof. In various embodiments, the client machine 101 may be implemented on a computer running a Microsoft Corp. operating system, an Apple Computer Inc. operating system (e.g., OSX), a Linux operating system, a UNIX operating system, a Palm operating system, a Symbian operating system, and/or other operating systems. While only a single client machine 101 is shown, the system can support a large number of concurrent sessions with many client machines 101.

The web servers 103, 111 accept requests (e.g., HTTP request) from the client machine 101 and provide responses (e.g., HTTP responses) back to the client machine 101. The responses preferably include an HTML document and associated media content that is retrieved from a respective content source 104, 112 that is communicatively coupled thereto. The responses of the web servers 103, 111 can include static content (content which does not change for the given request) and/or dynamic content (content that can dynamically change for the given request, thus allowing for customization the response to offer personalization of the content served to the client machine based on request and possibly other information (e.g., cookies) that it obtains from the client machine). Serving of dynamic content is preferably realized by one or more interfaces (such as SSI, CGI, SCGI, FastCGI, JSP, PHP, ASP, ASP .NET, etc.) between the web servers 103, 111 and the respective content sources 104, 112. The content sources 104, 112 are typically realized by a database of media content and associated information as well as database access logic such as an application server or other server side program.

The contextual link engine 109 maintains a library of media content item references indexed by web site and associates zero or more tags with each media content item reference of the library. The tag(s) associated with a given media content item reference provides contextual description of the media content item of the given reference. A user-side script is served as part of a response to one or more requests from the client machine 101. The user-side script is a program that may accompany an HTML document or it can be embedded directly in an HTML document. The program is executed by the browser application environment 107 of the client machine 101 when the document loads, or at some other time, such as when a link is activated. The execution of the user-side script on the client machine 101 processes the document and generates meta-data related thereto wherein such meta-data provides contextual description of the document. The meta-data is communicated to the contextual link engine 109 over a network connection between the client machine 101 and the contextual link engine 109. The contextual link engine 109 derives a set of one or more descriptors based upon the meta-data supplied thereto and searches over its library of media content item references to select zero or more references whose corresponding tag(s) match the descriptor(s) for the given meta-data. The contextual link engine 109 then builds a graphical user interface that includes links to the video content items for the selected references and communicates this graphical user interface to the client machine 101 for display thereon in conjunction with the requested document. Such operations are described in more detail below.

The web servers 103, 111, content sources 104, 112 and the contextual link engine 109 of FIG. 1 can be realized by separate computer systems, a network of computer processors and associated storage devices, a shared computer system or any combination thereof. In an illustrative embodiment, the web servers 103, 111, content sources 104, 112 and the contextual link engine 109 are realized by networked server devices such as standard server machines, mainframe computers and the like.

The system 100 carries out a process for contextual aggregation of media content and presentation of such aggregated media content to users as illustrated in FIG. 1. The process begins in step 1 wherein the contextual link engine 109 maintains a library of media content item references indexed by web site and associates zero or more tags with each media content item reference of the library. The tag(s) associated with a given media content item reference provides contextual description of the media content item of the given reference. In step 2, the web server 103 and content source 104 are configured to serve one or more HTML documents and possibly files associated therewith as part of a web site.

In step 3, the browser application environment 107 of the client machine 101 issues an HTML requests that references at least one of the HTML documents served by the web server 103 and content source as configured in step 2. The web server 103 (and/or the content source 104) generates a response to the request. The response includes one or more HTML documents, possibly files associated with the request, and a user-side script. The user-side script is a program that can accompany an HTML document or is directly embedded in an HTML document. The user-side script can be included in the response for all requests received by the web server 103 or for particular request(s) received by the web server 103. In step 4, the response generated by the web server 103 is communicated from the web server 102 to the client machine 101 over the network 105.

In step 5, the browser application environment 107 of the client machine 101 receives the response (one or more HTML documents, possibly files associated with the request, and a user-side script) issued by the web server 103.

In step 6, the browser application environment 107 of the client machine 101 invokes execution of the user-side script of the response received in step 5. The user-side script is executed by the browser application environment 107 when the HTML document of the response loads, or at some other time. The execution of the user-side script operates to identify the URL(s) for the HTML document(s) of the response received in step 5 and identify meta-data related to such HTML document(s). The meta-data provides contextual description of such HTML documents. The meta-data can be extracted from the HTML document(s), such as the title, description, keyword(s) and/or links embedded as part of tags within the HTML document(s). The meta-data might also be derived from analysis of the source HTML of documents, such as textual keywords identified within the source HTML. The identified keywords can be all text that is part of the source HTML, particular html text that is part of the source HTML (e.g., underlined text, bold text, text surrounded by header tags, etc.) or text identified by other suitable keyword extraction techniques. The meta-data might also be the source html of the HTML document(s). The execution of the user-side script then generates and communicates a message to the contextual link engine 109 which includes the URL and the meta-data for the HTML document(s) as identified by the script.

In step 7, the contextual link engine 109 receives the message communicated from the client machine in step 6. In step 8, in response to receipt of the message in step 7, the contextual link engine 109 derives a set of one or more descriptors based upon the meta-data supplied thereto as part of the message. Such derivation can be a simple extraction. For example, the contextual link engine 109 can extract the meta-data (e.g., title, keywords) from the body of the message whereby the meta-data itself represents one or more descriptors. In an alternate embodiment, the derivation of descriptors can be more complicated. For example, the contextual link engine 109 can process the meta-data (e.g., html source) to identify keywords therein, the identified keywords representing the set of descriptors. The identified keywords can be all text that is part of the meta-data, particular html text that is part of the meta-data (e.g., underlined text, bold text, text surrounded by header tags, etc.) or text identified by other suitable keyword extraction techniques.

In step 9, the contextual link engine 109 searches over the library of media content item references maintained therein (step 1) to select zero or more media content item references whose corresponding tag(s) match the descriptor(s) derived in step 8. The selection process of step 9 provides for contextual matching and can be rigid in nature (e.g., requiring that the tag(s) of the selected media content item references match all of the descriptors derived in step. Alternatively, the matching process of step 9 can be more flexible in nature based on similarity between the tag(s) of the selected media content item references and the descriptors derived in step 8. A weighted-tree similarity algorithm or other suitable matching algorithm can be used for the similarity-based matching. The selected media content item references are added to a list, which is preferably ranked according to similarity with the descriptors derived in step 8.

In step 10, the contextual link engine 109 builds a graphical user interface that includes links to the media content items referenced in the list generated in step 9. Preferably, the graphical user interface presents the title or subject for the respective media content items, links to the respective media content items, and possibly other ancillary information related to the respective media content items (such as a summary of the storyline of the respective media content item), all in ranked order. The link is a construct that connects to and retrieves a particular media content item and possibly other ancillary information over the web upon user selection thereof. The link includes a textual or graphical element that is selected by the user to invoke the link. The graphical user interface is preferably realized as a hierarchical user interface that includes a plurality of user interface windows or screens whereby a link in a given user interface window enables invocation of another user interface window associated with the link. In this manner, the user may traverse through the hierarchically linked user interface windows as desired. The graphical user interface can be realized by html, stylesheet(s), script(s) (such as Javascript, Action Script, JScript .NET), or other programming constructs suitable for networked communication to the client machine 101.

In step 11, the contextual link engine 109 communicates the graphical user interface built in step 10 to the client machine 101. In step 12, the client machine 101 receives the graphical user interface communicated by the contextual link engine 109 in step 11. In step 13, the browser application environment 107 of the client machine 101 renders the graphical user interface received in step 12 in conjunction with rendering the HTML document(s) received in step 5. The graphical user interface received in step 12 can be placed within the display of the HTML document(s) in a uniform manner, such as in a right-hand side column adjacent the content of the HTML document(s) or in the bottom-center of the page below the content of the HTML document(s). The graphical user interface received in step 12 can also be placed adjacent a particular portion of the HTML document(s) (e.g., next to a particular story). The screen space for the graphical user interface is preferably coded in the HTML document(s) and reserved for presentation of the graphical user interface. This reserved screen space may not be populated in the event that there is no contextual match for the request.

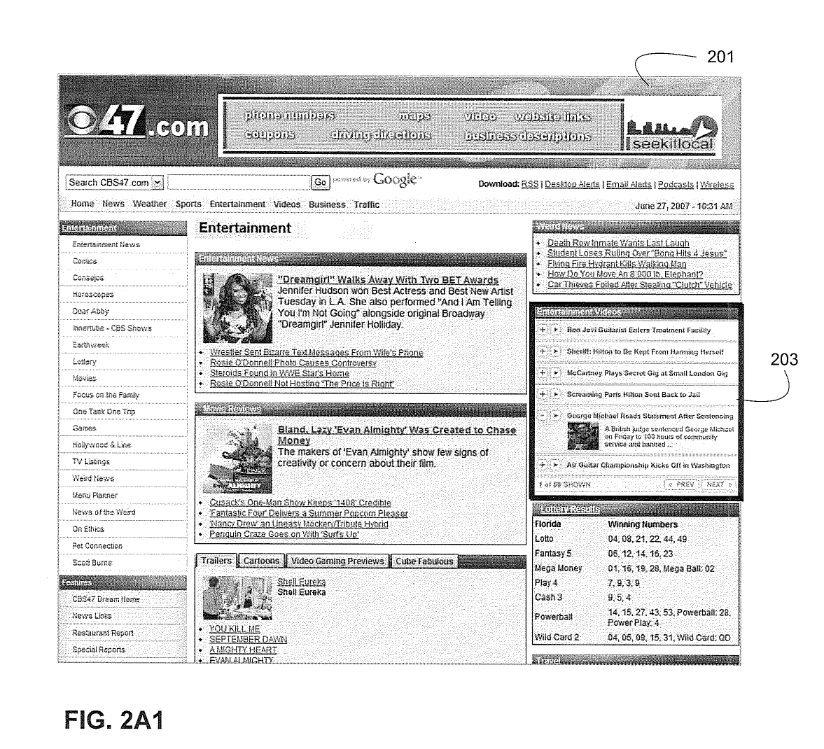

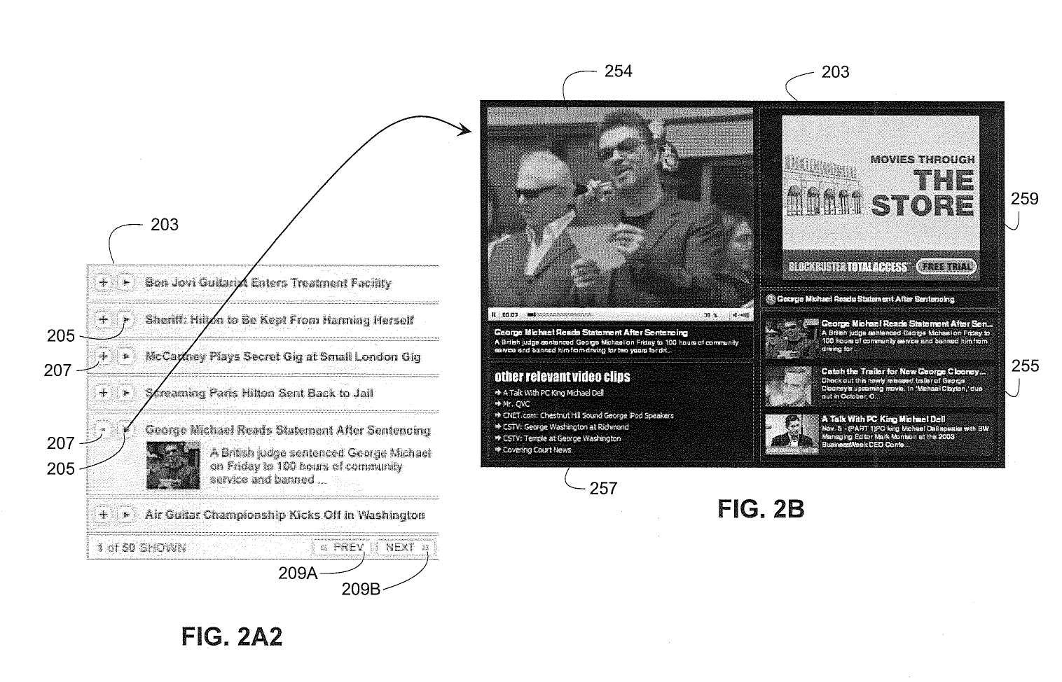

An exemplary graphical user interface generated by the contextual link engine 109 and rendered by the client machine 101 as part of step 13 is depicted as display window 203 in FIGS. 2A1 and 2A2. In this example, the display window 203, which is outlined by a black box for descriptive purposes, is placed in a right-hand side column adjacent the content of the requested HTML document(s) (labeled 201) as shown in FIG. 2A1. The display window 203 includes graphical icons 205 that realize links to respective media content items, which are displayed adjacent the title of the respective media content items as shown. The display window 203 also includes expansion widgets 207 for the respective media content items that when selected display a thumbnail image and summary storyline for the media content item as shown. The display window 203 also preferably provides a mechanism (e.g., previous button 209A, next button 209B) that allows the user to navigate through the media content items of the interface in their ranked order.

In step 14, the user-side script executing on the client machine 101 (or possibly another user-side script communicated to the client machine 101 from web server 103 or the contextual link engine 109) monitors the user interaction with the graphical user interface generated by the contextual link engine 109 and rendered by the client machine 101 in step 13. In the event that the user selects a link to a particular media content item (e.g., one of the graphical icons 205 in FIGS. 2A1 and 2A2), the browser application environment of the client machine 101 fetches the selected media content item, for example, from the web server 111 and content source 112.

In step 15, in the event that the user selects a link to a particular media content item (e.g., one of the graphical icons 205 in FIGS. 2A1 and 2A2), the client machine 101 sends a message to the contextual link engine 109 that identifies the selected media content item.

In step 16, the contextual link engine 109 receives the message communicated from the client machine in step 14. In step 17, in response to the receipt of this message, the contextual link engine 109 searches over the library of media content item references maintained therein (step 1) to select zero or more media content item references whose corresponding tag(s) match the tag(s) of the media content item identified by the message received in step 16. The selection process of step 17 provides for contextual matching and can be rigid in nature (e.g., requiring that the tag(s) of the selected media content item references match all of the tags of the user-selected media content item). The selection process of step 17 can also be more flexible in nature based on similarity between the tag(s) of the selected media content item references and the tag(s) of the user-selected media content item. A weighted-tree similarity algorithm or other suitable matching algorithm can be used for the similarity-based matching. The selected media content item reference(s) are added to a list, which is preferably ranked according to similarity with the tag(s) of the user-selected video content item.

In step 18, the contextual link engine 109 builds a graphical user interface that enables user access to the list of media content items referenced by the list generated in step 17. Preferably, the graphical user interface presents the title or subject for the respective media content items, links to the respective media content items, and possibly other ancillary information related to the respective media content items (such as a thumbnail image and/or summary of the storyline for the respective media content item). The graphical user interface can be realized by html, stylesheet(s), script(s) (such as Javascript, Action Script, JScript .NET), or other programming constructs suitable for networked communication to the client machine 101. In step 19, the contextual link engine 109 communicates the graphical user interface built in step 18 to the client machine 101.

In step 20, the client machine 101 receives the graphical user interface communicated by the contextual link engine 109 in step 19, In step 21, the browser application environment 107 of the client machine 101 renders graphical user interface received in step 20 in conjunction with playing the user-selected media content item fetched in step 14. In order to play the user-selected media content, the client machine's browser application environment 107 invokes a media player that is part of the environment 107. The media player can be installed as part of the browser application environment, downloaded as a plugin, or downloaded from the contextual link engine 109 as part of the process described herein.

In step 22, the operations loop back to step 14 to monitor user interaction with the graphical user interface rendered in step 21 and to generate and send a message to the contextual link engine 109 that identifies a media content item of the graphical user interface that is selected by the user during interaction with the interface, if any.

An exemplary graphical user interface generated by the contextual link engine 109 and rendered by the client machine 101 as part of step 21 is depicted as a display window 253 in FIG. 2B. In this example, the display window 253 launches as a pop-up window in response to user selection of the respective graphical icon 205 in the display window 203 of FIGS. 2A1 and 2A2. The display window 253 includes a screen area 254 for displaying the user-selected media content item (e.g., playing video in the event that the user-selected media content item is video content). The title and summary storyline of the user-selected media content item is displayed below the screen area 254 along with links to more detailed information related to the user-selected media content item. The display window 253 also includes at least one area (for example, the bottom right area 255 and the bottom left area 257) that display titles and links to media content items matched to the user-selected media content item in step 17. Note that area 255 also displays a thumbnail image and summary storyline for each respective media content item. The display window 253 can also include at least one area (for example, the top right area 259) for displaying one or more advertisements as shown.

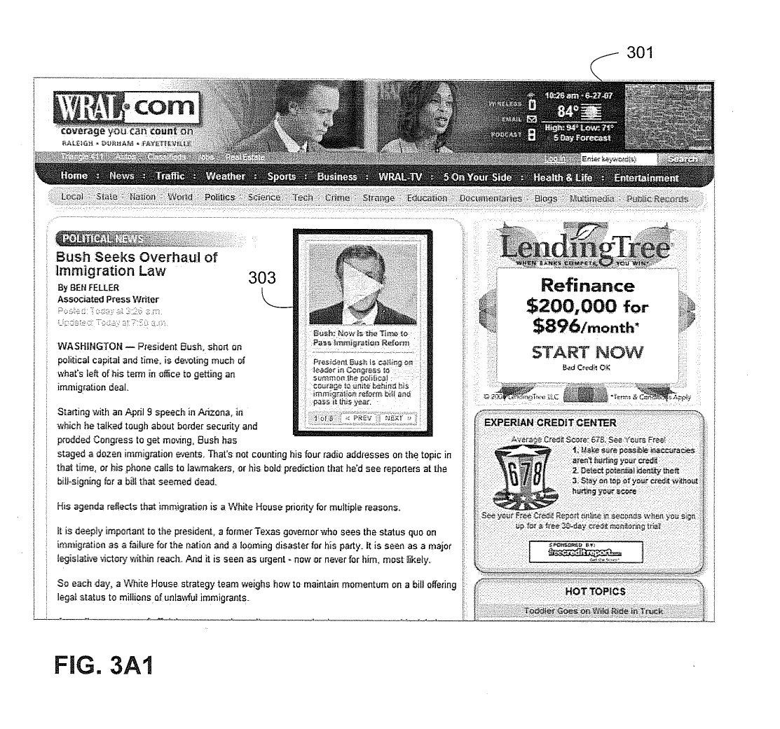

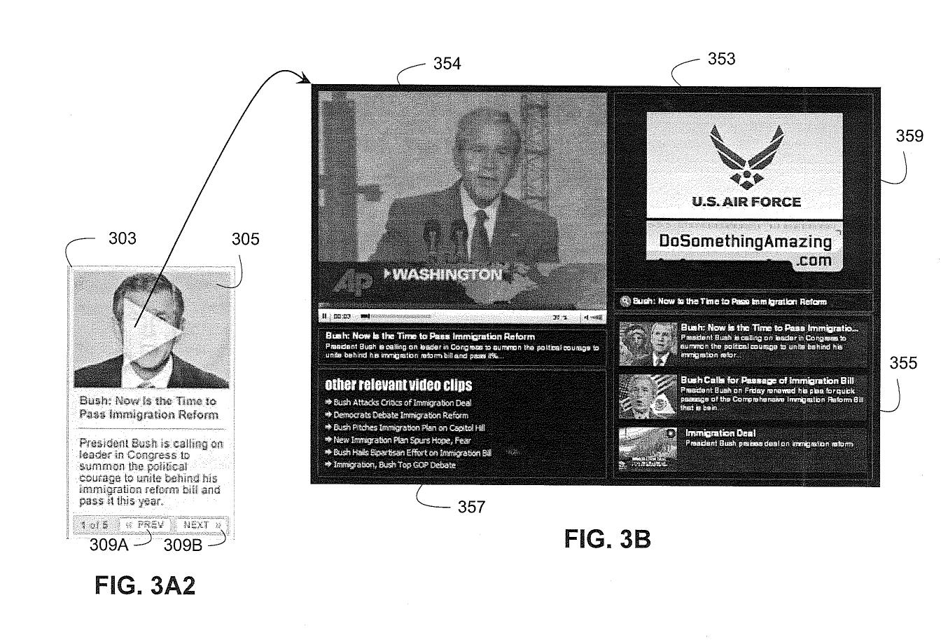

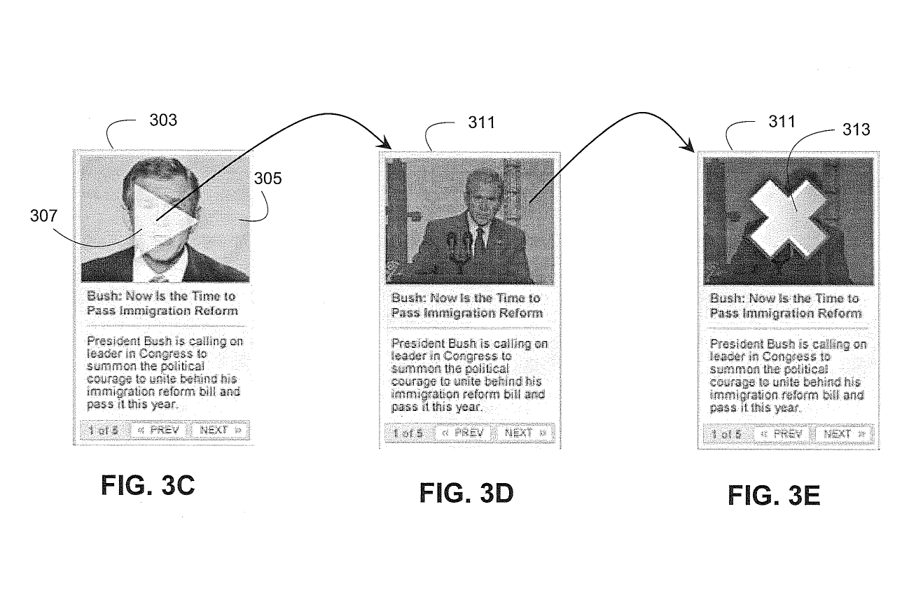

Turning to FIGS. 3A1 and 3A2, another exemplary graphical user interface generated by the contextual link engine 109 and rendered by the client machine 101 as part of step 13 is depicted as a display window 303. In this interface, the display window 303, which is outlined by a black box for descriptive purposes, is placed in a particular portion of the HTML document (labeled 301) adjacent to a corresponding story as shown in FIG. 3A1. The display window 303 includes a thumbnail image 305 for a respective media content item, which is displayed above the title and summary storyline of the respective media content item. A semi-opaque play button 307, which realizes a link to the respective media content item, overlays the thumbnail image 305. The display window 303 also preferably provides a mechanism (e.g., previous button 309A, next button 309B) that allows the user to navigate through the media content items of the interface in their ranked order. Advantageously, the thumbnail image 305 of the display window 303 also serves the purpose of a traditional story photo.

FIG. 3B illustrates another exemplary graphical user interface generated by the contextual link engine 109 and rendered by the client machine 101 as part of step 21. This interface is realized as a display window 353 which launches as a pop-up window in response to user selection of the play button 307 in the display window 303 of FIGS. 3A1 and 3A2. The display window 353 includes a screen area 354 for displaying the user-selected media content item (e.g., playing video in the event that the user-selected media content item is video content). The title and summary storyline of the user-selected media content item is displayed below the screen area 354 along with links to more detailed information related to the user-selected media content item. The display window 353 also includes at least one area (for example, a bottom right area 355 and a bottom left area 357) that display titles and links to media content items matched to the user-selected media content item in step 17. Note that area 355 also displays a thumbnail image and summary storyline for each respective media content item. The display window 353 can also include at least one area (for example, a top right area 359) for displaying one or more advertisements as shown.

In an alternate embodiment of the present invention, the operations of steps 15 to 20 as described above can be omitted and the operation of step 21 can be adapted to display (e.g., play) inline the selected media content item fetched in step 14 as part of the view of the requested HTML document(s) rendered in step 13. The inline display of the selected media content as part of the requested HTML document(s) provides a more seamless, uninterrupted user experience. FIGS. 3C-3D illustrate an example of such operations for the illustrative interface of FIGS. 3A1 and 3A2. In this example, the selection of the link (opaque play button 307) of the display window 303 invokes operations that fetch the selected media content item. The selected media content item is played inline in a display area 311 as a substitute for the thumbnail image 305 as shown in FIG. 3D. Preferably, the user can stop the playback of the selected media content item by clicking on the display area 311, which displays a stop icon 313 (or other suitable indicator) in the display area 311 as shown in FIG. 3E. In an alternate embodiment (not shown), the selected media content item can be played inline as part of the view of the requested HTML document(s) in a display area that substitutes some or all of the entire display window 305.

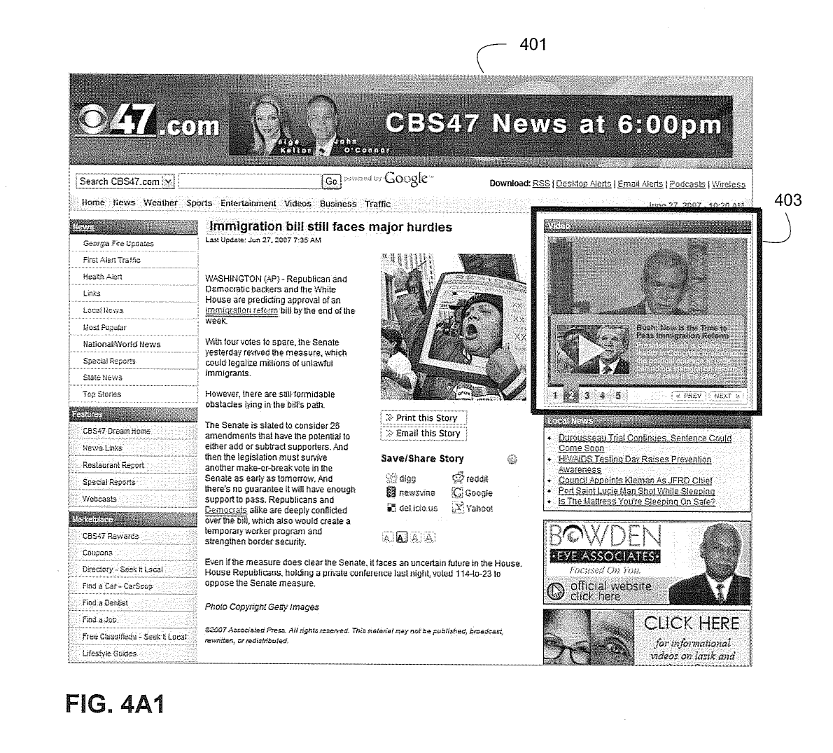

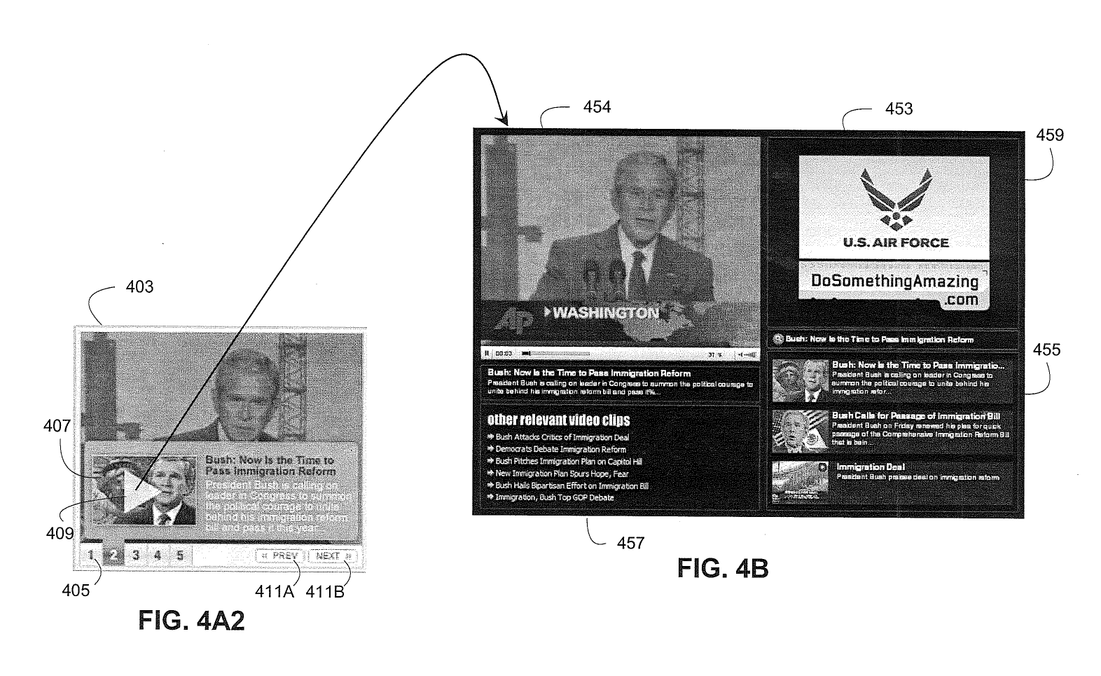

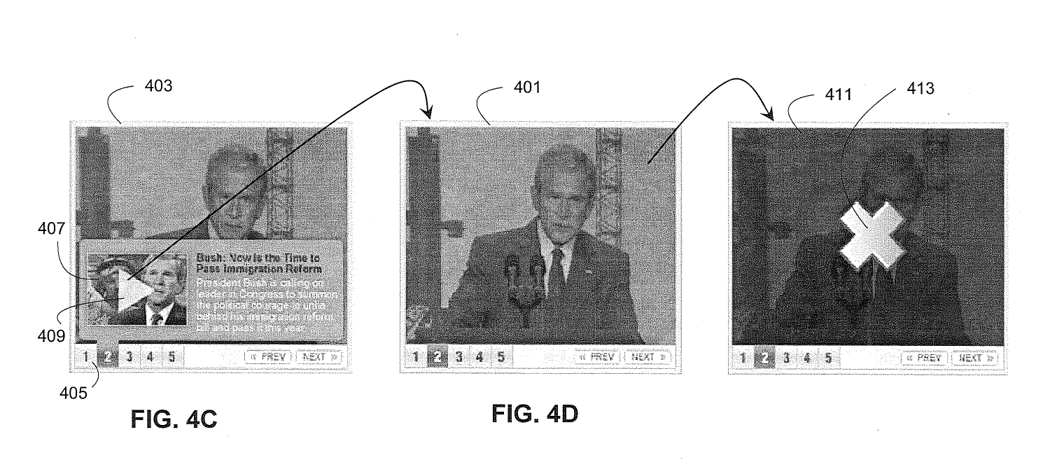

Other suitable graphical user interfaces enabling user access to a number of media content items can be generated by the contextual link engine 109 and rendered by the client machine 101 as part of step 13. For example, FIGS. 4A1 and 4A2 illustrate such a graphical user interface, which is realized by a display window 403 (outlined by a black box for descriptive purposes), placed in a right-hand side column adjacent the content of the requested HTML document(s) (labeled 401). The display window 403 includes numbered tabs 405 to provide for navigation through the media content items referenced by the list generated by the contextual link engine 109 in step 9. Upon rollover (or possibly selection) of a respective tab by the user, the display window 403 presents a thumbnail image 407 for the respective media content item, which is displayed to the left of the title and summary storyline of the respective media content item. A semi-opaque play button 409, which realizes a link to the respective media content item, overlays the thumbnail image 407. The display window 403 also preferably provides a mechanism (e.g., previous button 411A, next button 411B) that allows the user to navigate through the media content items of the interface in their ranked order.

FIG. 4B illustrates another exemplary graphical user interface generated by the contextual link engine 109 and rendered by the client machine 101 as part of step 21. This interface is realized as a display window 453 which launches as a pop-up window in response to user selection of the play button 409 in the display window 403 of FIGS. 4A1 and 4A2. The display window 453 includes a screen area 454 for displaying the user-selected media content item (e.g., playing video in the event that the user-selected media content item is video content). The title and summary storyline of the user-selected media content item is displayed below the screen area 454 along with links to more detailed information related to the user-selected media content item. The display window 453 also includes at least one area (for example, a bottom right area 455 and a bottom left area 457) that display titles and links to media content items matched to the user-selected media content item in step 17. Note that area 455 also displays a thumbnail image and summary storyline for each respective media content item. The display window 453 can also include at least one area (for example, a top right area 459) for displaying one or more advertisements as shown.

FIGS. 4C-4D illustrate an alternate embodiment of the present invention wherein the operations of steps 15 to 20 as described above are omitted and the operation of step 21 is adapted to display (e.g., play) inline the selected media content item fetched in step 14 as part of the view of the requested HTML document(s) rendered in step 13. The inline display of the selected media content as part of the requested HTML document(s) provides a more seamless, uninterrupted user experience. In this example, the selection of the link (opaque play button 407) of the display window 403 invokes operations that fetch the selected media content item. The selected media content item is played inline in a display area 411 as a substitute for the display of the thumbnail image 407 and associated information as shown in FIG. 4D. Preferably, the user can stop the playback of the selected media content item by clicking on the display area 411, which displays a stop icon 413 (or other suitable indicator) in the display area 411 as shown in FIG. 4E.

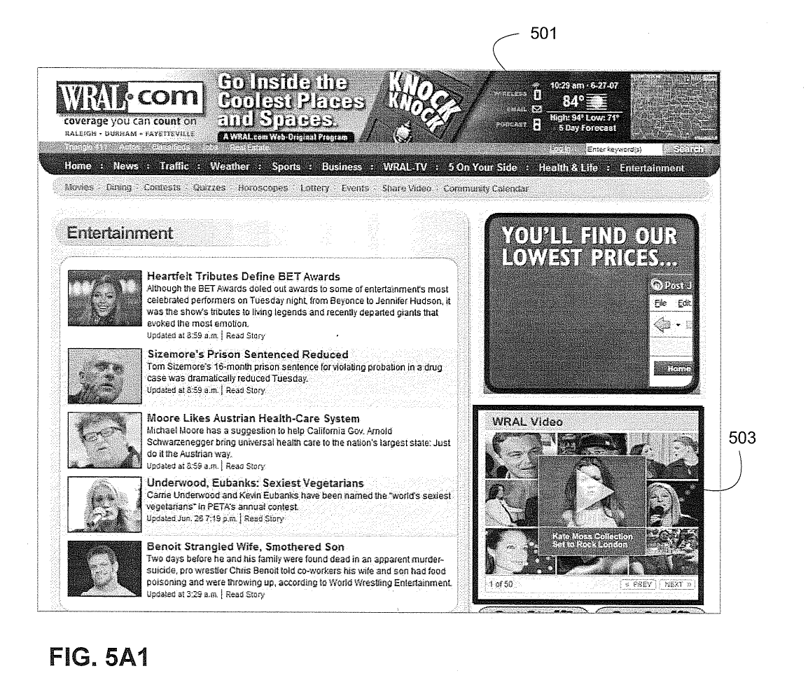

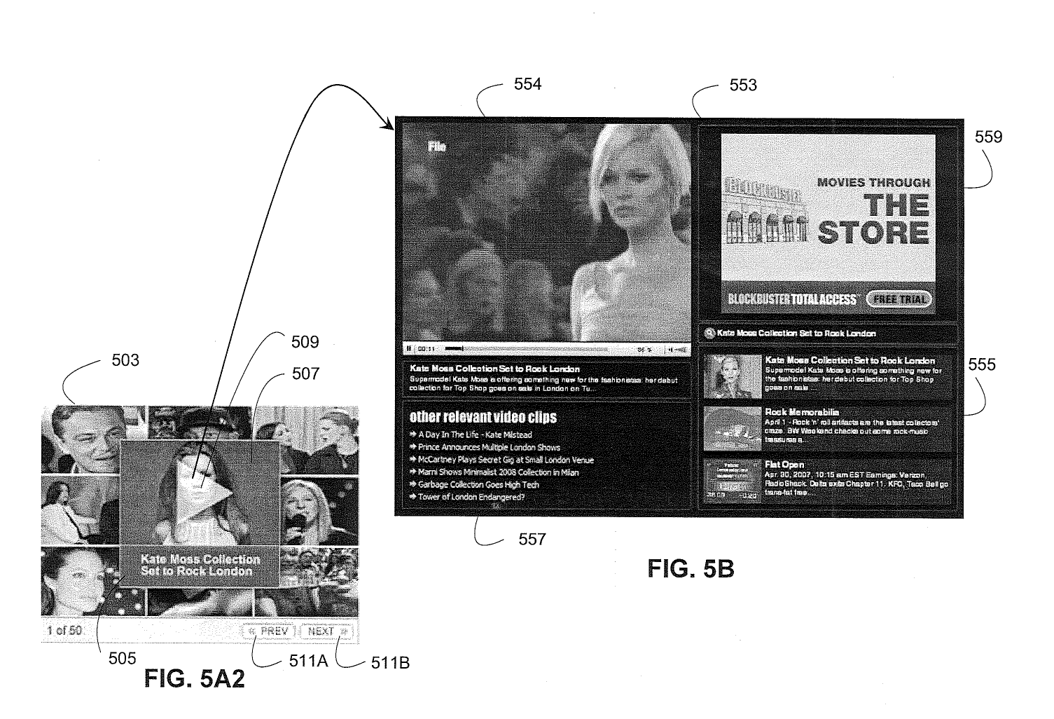

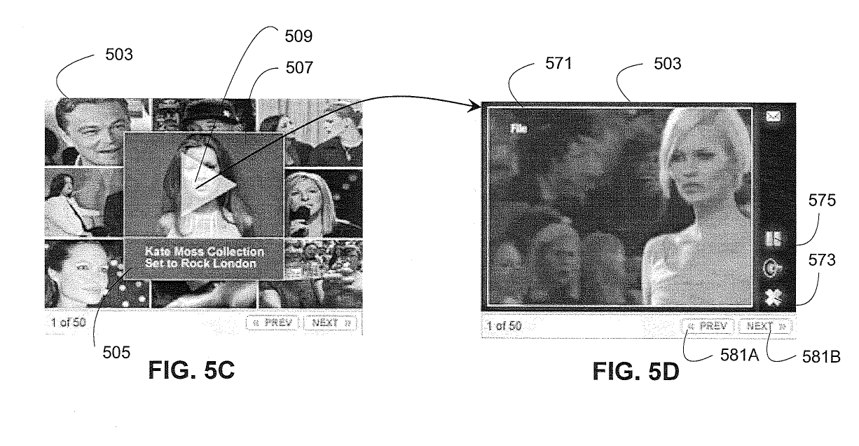

FIGS. 5A1 and 5A2 illustrate yet another graphical user interface generated by the contextual link engine 109 and rendered by the client machine 101 as part of step 13 to thereby enable user access to a number of media content items. The graphical user interface is realized by a display window 503 (outlined by a black box for descriptive purposes) placed in a right-hand side column adjacent the content of the requested HTML document(s) (labeled 501). The display window 503 includes an array of thumbnail images 505 for respective media content items referenced by the list generated by the contextual link engine 109 in step 9. Upon rollover (or possibly selection) of a respective thumbnail image by the user, a central display area 505 presents a thumbnail image 505 for the corresponding media content item together with the title of the respective media content item preferably disposed below the image 505. A semi-opaque play button 509, which realizes a link to the respective media content item, overlays the thumbnail image 507. The display window 503 also preferably provides a mechanism (e.g., previous button 511A, next button 511B) that allows the user to navigate through the thumbnail images for the media content items of the interface in their ranked order.

FIG. 5B illustrates yet another exemplary graphical user interface generated by the contextual link engine 109 and rendered by the client machine 101 as part of step 21. This interface is realized as a display window 553 which launches as a pop-up window in response to user selection of the play button 509 in the display window 503 of FIGS. 5A1 and 5A2. The display window 553 includes a screen area 554 for displaying the user-selected media content item (e.g., playing video in the event that the user-selected media content item is video content). The title and summary storyline of the user-selected media content item is displayed below the screen area 554 along with links to more detailed information related to the user-selected media content item. The display window 553 also includes at least one area (for example, a bottom right area 555 and a bottom left area 557) that display titles and links to media content items matched to the user-selected media content item in step 17. Note that area 555 also displays a thumbnail image and summary storyline for each respective media content item. The display window 453 can also include at least one area (for example, a top right area 559) for displaying one or more advertisements as shown.

FIGS. 5C-5D illustrate an alternate embodiment of the present invention wherein the operations of steps 15 to 20 as described above are omitted and the operation of step 21 is adapted to display (e.g., play) inline the selected media content item fetched in step 14 as part of the view of the requested HTML document(s) rendered in step 13. The inline display of the selected media content as part of the requested HTML document(s) provides a more seamless, uninterrupted user experience. In this example, the selection of the link (opaque play button 509) of the display area 505 invokes operations that fetch the selected media content item. The selected media content item is played inline in a display window 571 as a substitute for the array of thumbnail images of window 503 as shown in FIG. 5D. Preferably, the interface of FIG. 5D also includes buttons 573, 575 to stop and pause playback of the selected media item as well as other options (such as email a reference to the selected media item to a designated email address) as shown. The interface of FIG. 5D also preferably provides a mechanism (e.g., previous button 581A, next button 581B) that allows the user to navigate through the inline display of media content items of the interface in their ranked order.

In another embodiment of the present invention, the user-side script (or parts thereof) executed by the browser application environment in step 6 need not be communicated to the requesting client machine for all requests. Instead, the user-side script (or parts thereof) can be persistently stored locally on the requesting client machine and accessed as needed. In such a configuration, the user-side script can be stored as part of a data cache on the requesting client machine or possibly as part of a plug-in or application on the requesting client machine. In such a configuration, the user-side script is stored locally on the client machine prior to a given request being issued by the requesting client machine.

In yet another embodiment of the present invention, the user-side script executed by the browser application environment in step 6 can omit the processing that identifies the meta-data related to the requested HTML document(s). In this case, the message communicated from the client machine 101 to the contextual link engine 109 includes the URL of the requested HTML document(s) (and not such meta-data). In response to this message, the contextual link engine 109 uses the URL to fetch the corresponding HTML document(s) and then carries out processing that identifies the meta-data related to the particular HTML document(s) as described herein. The contextual link engine 109 then such meta-data to derive a set of one or more descriptors based upon such meta-data as described above with respect to step 8 and the operations continue on to step 9 and those following.

In still another embodiment of the present invention, the processing operations that identify meta-data related to the requested HTML document(s) can be carried out as part of the content serving process of the web server 103. In this configuration, the web server 103 cooperates with the contextual link engine 109 to initiate the operations that derive a set of one or more descriptors based upon such meta-data as described above with respect to step 8 and the operations continue on to step 9 and those following.

In the illustrative embodiment described above with respect to FIG. 1, the user-side processing that automatically generates the meta-data which provides context for the information presented to the user is invoked as part of a web browser environment where the user client machine issues requests for data content. In alternate embodiments, it can be invoked by any application and/or environment in which a user interacts with a client machine to display and interact with information (i.e., text content, image content, video content, audio content or any combination thereof). In conjunction with such interaction, user-side processing on the client machine automatically generates meta-data related to the information presented to the user. Such meta-data provides context for the information presented to the user. The processing continues as described above where the contextual link engine identifies particular media content items that correspond to the meta-data, builds a graphical user interface that enables user access to these particular media content items, and outputs the graphical user interface for communication to the client machine where it is rendered thereon.

For example, it is contemplated that an application executing on the client machine can invoke functionality that extracts tag annotations of an image file or video file selected by a user and that utilizes such tag annotations as contextual meta-data. The processing continues as described above where the contextual link engine identifies particular media content items that correspond to the contextual meta-data, builds a graphical user interface that enables user access to these particular media content items, and outputs the graphical user interface for communication to the client machine where it is rendered thereon.

In another example, it is contemplated that a video player application executing on the client machine can invoke speech recognition functionality that generates text corresponding to the audio track of a video file selected by a user. Such text is utilized as contextual meta-data and the processing continues as described above where the contextual link engine identifies particular media content items that correspond to the contextual meta-data, builds a graphical user interface that enables user access to these particular media content items, and outputs the graphical user interface for communication to the client machine where it is rendered thereon.

There have been described and illustrated herein several embodiments of a method, system and apparatus for contextual aggregation of media content items and for presentation of such aggregated media content items to a user. While particular embodiments of the invention have been described, it is not intended that the invention be limited thereto, as it is intended that the invention be as broad in scope as the art will allow and that the specification be read likewise. For example, particular graphical user interface elements have been disclosed, it will be appreciated that other graphical user interface elements can be used as well. In addition, while particular processing frameworks and platforms have been disclosed, it will be understood that other suitable processing frameworks and platforms can be used. It will therefore be appreciated by those skilled in the art that yet other modifications could be made to the provided invention without deviating from its spirit and scope as claimed.

What is claimed is:

1. A method for aggregating data content and presentation of such aggregated data content to users comprising:
performing processing at the client machine that automatically identifies meta-data which provides context for information presented to the user at the client machine;
communicating the meta-data to a contextual link engine that maintains a library of media content items and that identifies zero or more particular media content items that correspond to the meta-data supplied thereto;
building a graphical user interface that enables user access to the zero or more particular media content items corresponding the meta-data supplied to the contextual link engine;
communicating said graphical user interface to said client machine; and
rendering said graphical user interface in conjunction with presentation of the data returned from the server at the client machine.

2. A method according to claim 1, further comprising:
associating zero or more tags with each media content item of the library maintained by the contextual link engine.

3. A method according to claim 2, wherein:
the media content items that correspond to the meta-data supplied to the contextual link engine are identified at the contextual link engine by i) deriving at least one descriptor corresponding to the meta-data, and ii) identifying media content items whose tags match the at least one descriptor corresponding to the meta-data.

4. A method according to claim 1, wherein:
the information presented to the user on the client machine is returned from a server in response to a request communicated to the server from the client machine.

5. A method according to claim 4, wherein:
the processing performed at the client machine for identifying meta-data is part of a user-side script invoked for execution on the client machine subsequent to receipt of the information at the client machine.

6. A method according to claim 5, wherein:
the user-side script is communicated from the server to the client machine in response to the request issued by the client machine.

7. A method according to claim 5, wherein:
the user-side script is persistently stored locally on the client machine prior to the request being issued by the client machine.

8. A method according to claim 5, wherein:
meta-data identified by the user-side script is derived by extracting information embedded as part of data returned by the server.

9. A method according to claim 8, wherein:
the meta-data identified by the user-side script includes at least one of a title, a description, at least one keyword, and at least one link.

10. A method according to claim 1, wherein:
the processing performed at the client machine for identifying meta-data includes extraction of tag annotations of a file selected by a user, wherein the tag annotations provide context for the file.

11. A method according to claim 1, wherein:
the processing performed at the client machine for identifying meta-data includes invocation of speech recognition functionality that generates text data corresponding to audio content of a file processed on the client machine, wherein the text data provides context for the file.

12. A method according to claim 1, wherein:
the graphical user interface presents text characterizing the particular media content items and links to the particular media content items.

13. A method according to claim 12, wherein:
user selection of a given link invokes communication of a message from the client machine to the contextual link engine, the message identifying a media content item corresponding to the given link,
wherein the contextual link engine identifies zero or more particular media content items that correspond to the media content item identified by the message communicated thereto, builds a second graphical user interface that enables user access to the zero or more particular media content items corresponding the media content item identified by the message communicated thereto, and communicates said second graphical user interface to said client machine for rendering at the client machine.

14. A method according to claim 13, wherein:
the second graphical user interface includes a pop-up window, wherein a portion of the pop-up window provides for playback of a media content item corresponding to the given link.

15. A method according to claim 12, wherein:
user selection of a given link invokes presentation of a pop-up window for playback of a media content item corresponding to the given link.

16. A method according to claim 12, wherein:
user selection of a given link invokes inline playback of a media content item corresponding to the given link.

17. A method according to claim 12, wherein:
a given link is realized by an opaque button overlying an image associated with a particular media content item.

18. A method according to claim 12, wherein:
the graphical user interface includes a plurality of images associated with the particular media content items, wherein a link to a particular media content item is presented upon rollover of a given image associated therewith.

19. A method according to claim 12, wherein:
the graphical user interface includes means for navigating through the particular media content items.

20. A system for aggregating data content and presentation of such aggregated data content to users comprising:
a client machine, a server, and a contextual link engine;
wherein the client machine includes means for automatically identifying meta-data which provides context for information presented to the user at the client machine and for communicating the meta-data to the contextual link engine;
wherein the contextual link engine includes
means for maintaining a library of media content items,
means for identifying zero or more particular media content items that correspond to the meta-data supplied thereto,
means for building a graphical user interface that enables user access to the zero or more particular media content items corresponding the meta-data supplied to the contextual link engine, and
means for communicating said graphical user interface to the client machine for rendering thereon.

21. A system according to claim 20, wherein:
the contextual link engine includes means for associating zero or more tags with each media content item of the library maintained by the contextual link engine.

22. A system according to claim 21, wherein:
the content link engine includes means for deriving at least one descriptor corresponding to the meta-data and means for identifying media content items whose tags match the at least one descriptor corresponding to the meta-data.

23. A system according to claim 20, wherein:
the information presented to the user on the client machine is returned from a server in response to a request communicated to the server from the client machine.

24. A system according to claim 23, wherein:
the means for automatically identifying meta-data on the client machine is part of a user-side script invoked for execution on the client machine subsequent to receipt of the information at the client machine.

25. A system according to claim 24, wherein:
the user-side script is communicated from the server to the client machine in response to the request issued by the client machine.

26. A system according to claim 24, wherein:
the user-side script is persistently stored locally on the client machine prior to the request being issued by the client machine.

27. A system according to claim 24, wherein:
the meta-data identified by the user-side script is derived by extracting information embedded as part of the data returned by the server.

28. A system according to claim 27, wherein:
the meta-data identified by the user-side script includes at least one of a title, a description, at least one keyword, and at least one link.

29. A system according to claim 20, wherein:
the means for automatically identifying meta-data on the client machine includes means for extraction of tag annotations of a file selected by a user, wherein the tag annotations provide context for the file.

30. A system according to claim 20, wherein:
the means for automatically identifying meta-data on the client machine includes means for invocation of speech recognition functionality that generates text data corresponding to audio content of a file processed on the client machine, wherein the text data provides context for the file.

31. A system according to claim 20, wherein:
the graphical user interface presents text characterizing the particular media content items and links to the particular media content items.

32. A system according to claim 31, wherein:
user selection of a given link invokes communication of a message from the client machine to the contextual link engine, the message identifying a media content item corresponding to the given link,
wherein the contextual link engine identifies zero or more particular media content items that correspond to the media content item identified by the message communicated thereto, builds a second graphical user interface that enables user access to the zero or more particular media content items corresponding the media content item identified by the message communicated thereto, and communicates said second graphical user interface to said client machine for rendering at the client machine.

33. A system according to claim 32, wherein:
the second graphical user interface includes a pop-up window, wherein a portion of the pop-up window provides for playback of a media content item corresponding to the given link.

34. A system according to claim 31, wherein:
user selection of a given link invokes presentation of a pop-up window for playback of a media content item corresponding to the given link.

35. A system according to claim 31, wherein:
user selection of a given link invokes inline playback of a media content item corresponding to the given link.

36. A system according to claim 31, wherein:
a given link is realized by an opaque button overlying an image associated with a particular media content item.

37. A system according to claim 31, wherein:
the graphical user interface includes a plurality of images associated with the particular media content items, wherein a link to a particular media content item is presented upon rollover of a given image associated therewith.

38. A system according to claim 31, wherein:
the graphical user interface includes means for navigating through the particular media content items.

39. An apparatus for aggregating data content comprising:
means for maintaining a library of media content items;
means for receiving or automatically identifying meta-data which provides contextual information;
means for identifying zero or more particular media content items that correspond to the meta-data;
means for building a graphical user interface that enables user access to the zero or more particular media content items corresponding the meta-data; and
means for outputting the graphical user interface.

40. An apparatus according to claim 39, further comprising:
means for associating zero or more tags with each media content item of the library maintained by the contextual link engine.

41. An apparatus according to claim 39, wherein:
the means for receiving or automatically identifying meta-data operates over each given request of a plurality of requests to generate contextual information corresponding to the given request.

42. An apparatus according to claim 39, wherein:
the means for identifying zero or more particular media content items includes i) means for deriving at least one descriptor corresponding to the meta-data and ii) means for identifying media content items whose tags match the at least one descriptor corresponding to the meta-data.

43. An apparatus according to claim 39, wherein:
the graphical user interface presents text characterizing the particular media content items and links to the particular media content items.

44. An apparatus according to claim 43, wherein:
user selection of a given link invokes communication of a message to the apparatus the message identifying a media content item corresponding to the given link,
wherein the apparatus includes means for identifying zero or more particular media content items that correspond to the media content item identified by the message communicated thereto, means for building a second graphical user interface that enables user access to the zero or more particular media content items corresponding the media content item identified by the message communicated thereto, and means for outputting the second graphical user interface.

45. An apparatus according to claim 44, wherein:
the second graphical user interface includes a pop-up window, wherein a portion of the pop-up window provides for playback of a media content item corresponding to the given link.

46. An apparatus according to claim 43, wherein:
user selection of a given link invokes presentation of a pop-up window for playback of a media content item corresponding to the given link.

47. An apparatus according to claim 43, wherein:
user selection of a given link invokes inline playback of a media content item corresponding to the given link.
